(19) United States
(12) Patent Application Publication
(10) Pub. No.: US 2010/0318921 A1
(43) Pub. Date: Dec. 16, 2010

(54) DIGITAL EASEL COLLABORATION SYSTEM AND METHOD

(76) Inventors: Marc Trachtenberg, New York, NY (US); Steven Gage, Merrick, NY (US); Karl Krantz, Stamford, CT (US)

Correspondence Address: ST. ONGE STEWARD JOHNSTON & REENS, LLC, 986 BEDFORD STREET, STAMFORD, CT, 06905-5619, US

(21) Appl. No.: 12/816,114

(22) Filed: Jun. 15, 2010

Related U.S. Application Data
(60) Provisional application No. 61/187,451, filed on Jun. 16, 2009.

(51) Int. Cl. G06F 3/048; G06F 3/041

(52) U.S. Cl. 715/751; 345/173

(57) ABSTRACT

A system for digital content collaboration has several conference rooms, each having a digital easel and a group display device providing a plurality of image display locations. Each digital easel has a touch sensitive display and a pointing device to receive annotations and manipulations of digital content items. The group display device displays a plurality of digital content items, each in one of several image display locations. Each digital easel has several predefined image display areas, and each image display area is associated with one of the image display locations of the group display device. The digital easel is operable to receive a selection of a digital content item for any of the plurality of image display locations from a user via the pointing device. Upon receipt of the selection, the system automatically displays the selected digital content item in the associated image display location of the group display device and to simultaneously in the image display area of the digital easel.

### CROSS-REFERENCE TO RELATED APPLICATIONS

The present application claims the benefit under 35 U.S.C. §119(e) of the U.S. Provisional Patent Application Ser. No. 61/187,451, filed on Jun. 16, 2009, the content of which is incorporated herein by reference.

### FIELD OF THE INVENTION

The invention pertains to the field of collaboration systems and methods, and in particular teleconference collaboration systems and methods.

### BACKGROUND OF THE INVENTION

Digital collaboration systems in the prior art provide means to collaborate with others using digital content items. However, the devices and methods of such prior collaboration systems do not provide an efficient and intuitive means to collaborate with others, especially in a teleconference environment where collaboration occurs in real-time among persons in disparate locations.

Therefore, what is desired is a digital easel collaboration system that provides an efficient and intuitive means to collaborate with others using digital content items including electronic documents, rich media content (e.g., static and dynamic audio/visual content), and many other types of digital content items, in a teleconference environment where collaboration can occur in real-time among persons in disparate locations.

### SUMMARY OF THE INVENTION

In one embodiment, the invention provides a system for digital content collaboration and sharing having first and second conference rooms, with each room having a digital easel and a group display device providing a plurality of image display locations. Each digital easel has a touch sensitive display and a pointing device and is operable to receive annotations and manipulations of digital content items via the pointing device. The group display device is operable to display a plurality of digital content items, with one digital content item in each of one of the plurality of image display locations. Each digital easel has a plurality of predefined image display areas on the display thereof. Each image display area is associated with one of the image display locations of the group display device. Each digital easel is operable to access a plurality of digital content items and is operable to receive a selection of a digital content item for any one of the plurality of image display locations from a user via the pointing device. Upon receipt of a selection of a selected digital content item for a selected image display location from the user, the system is operable to automatically display the selected digital content item in the associated image display location of the group display device.

In another embodiment of the invention, upon receipt of the selection of the selected digital content item for the selected image display area from the user, the system automatically displays the selected digital content item in the associated image display location of the group display device and simultaneously displays the selected digital content item in the image display area of the digital easel.

In yet another embodiment of the invention, the group display device has a plurality of monitors and has means for generating a video signal for each one of the plurality of monitors.

In a further embodiment of the invention, the group display device comprises a projection device operable to project a projected image on a projection surface and the projected image comprising a plurality of digital content items.

In yet a further embodiment of the invention, each digital easel and projection device of the first and second conference rooms are interconnected via a data network; and the display of each digital easel and the group display devices are synchronized over the data network.

### BRIEF DESCRIPTION OF THE DRAWINGS

For a complete understanding of the above and other features of the invention, reference shall be made to the following detailed description of the preferred embodiments of the invention and to the accompanying drawings, wherein:

FIG. 1 is a schematic view of a teleconference comprising multiple teleconference rooms, each having a digital easel;

FIG. 2 is a schematic view of a digital easel; and

FIG. 3 is a schematic view of a group display comprising several monitors.

### DETAILED DESCRIPTION OF THE INVENTION

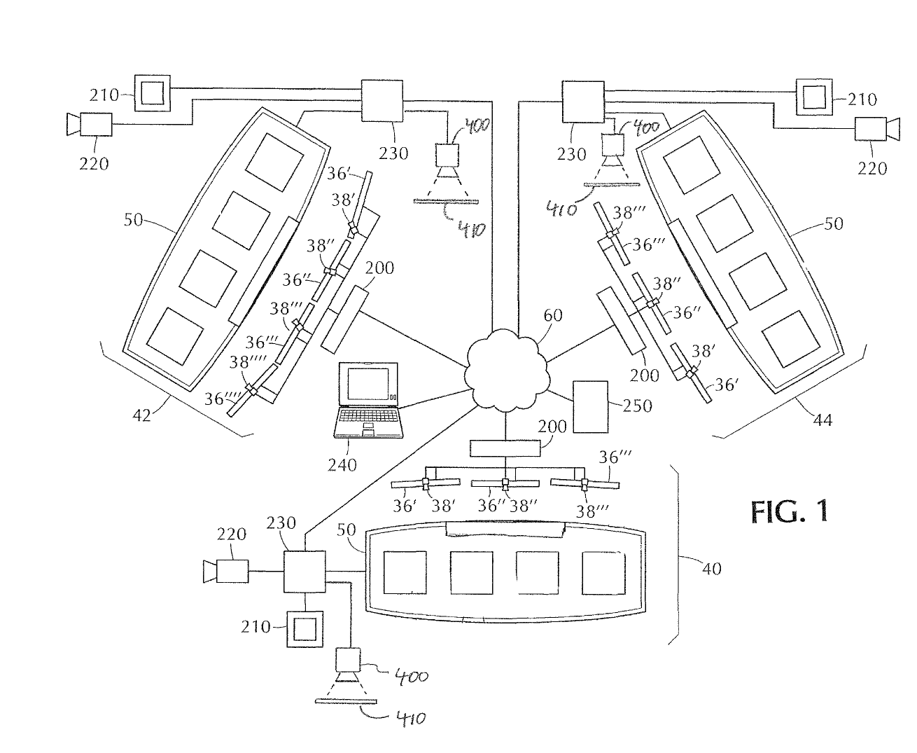

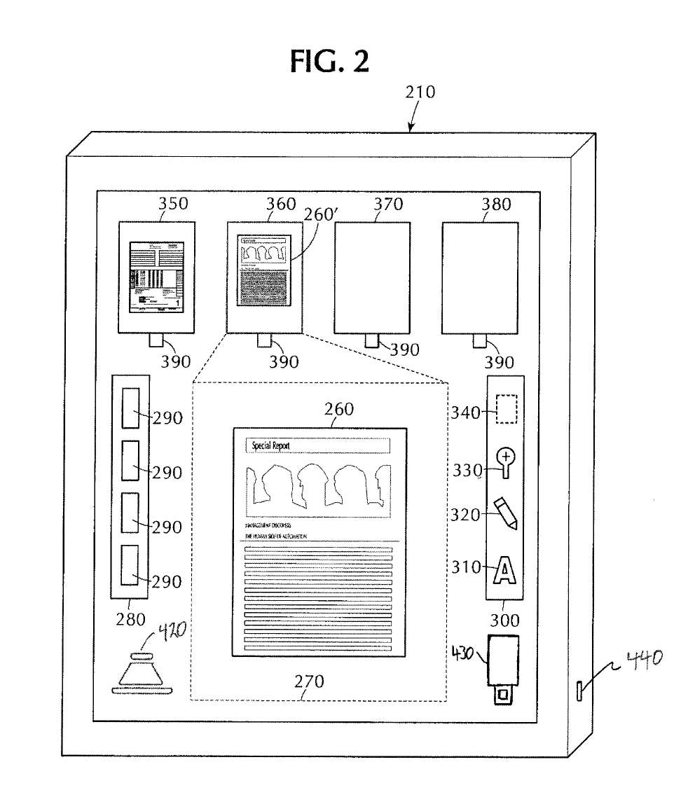

Referring to FIGS. 1-2 the digital easel collaboration system of the present invention provides an efficient and intuitive means to collaborate with others using digital content items including electronic documents, rich media content (e.g., static and dynamic audio/visual content), and many other types of digital content items, in a teleconference environment. In particular, the invention provides a content-type independent collaboration system, method and apparatus for sharing, annotation and synchronized publication and browsing of digital content items amongst users in any location.

Referring to FIG. 1, a teleconference employing the digital easel collaboration system may include several conference rooms 40, 42, 44 connected over a private and/or public network 60, possibly through a Network Operations Center (NOC). Each conference room may include a conference table 50, a plurality of participant displays 36 which show images of remote participants located in the other locations, and a plurality of participant cameras 38 which capture images of the participants in the room.

Each participant camera 38 and participant display 36 may be connected to a local audio/visual (A/V) server 200 at each site, which is connected to a central server 250 at the network operations center (NOC) via the network 60. A desktop client, such as a personal computer 240, may also interconnect with the central server 250 via the network 60. Each site also may include a local collaboration server 230 which interconnects collaboration devices within a room and which connects to other collaboration devices in other rooms via the network 60 and central server 250.

Referring to FIG. 2, each room in a conference preferably has a digital easel 210 or, digital white board, which provides a natural interface for users to annotate and publish electronic documents 260 or other digital content items in a conference. Products suitable as platforms for a digital easel include Samsung™ display panels with 3M™ touch-sensitive overlays, or other suitable display panels and overlays. Preferably, the easel 210 has a touch-sensitive electronic display and an input device, such as a stylus or pen. The Easel 210 may be mounted to or placed on a fixed or movable support, such as a wall, table or stand. Alternatively, the easel 210 may be portable, and may comprise wireless tablet having a display (not shown), which is provided with a wired or wireless stylus or pen. Alternatively or additionally, the easel 210 may be programmed to recognize and respond to multi-touch hand gestures made on or adjacent the surface of the display. The display of the easel 210 has a work area 270 (usually in a center area of the display) in which a user may view and manipulate and/or annotate a digital content item, such as an electronic document, presentation, video, or image, or another suitable digital content item. Preferably, the system has a repository of shared digital content items available to all easels 210 in a conference, and the display of each easel 210 is operable to present a visual shared digital content item list 280 representing the digital content items 290 in the repository, such as thumbnail images of the digital content items. The repository of shared digital content items may reside on the central server 250 or another location.

A user may select a digital content item, such as an electronic document 290 from the shared digital content item list 280 by using the pointing device to drag a document 290 to the work area 270. Other methods to select a digital content item are also feasible, such as a menu selection, or a double-touch/click command, or any other suitable method. Upon selection of a document from the repository, the easel 210 displays the document 260 in the work area 270. The easel 210 preferably provides a number of annotation and manipulation tools in a tools menu list 300 presented on the display. Such tools may include a text or font tool 310, a pencil or drawing tool 320, a zoom tool 330, and a cropping tool 340, as well as other tools such as pen size tool, a pen color tool, a highlighter tool, an eraser tool, a rectangle shape tool, a circle tool, and other such tools, and possibly menus and sub-menus for tools. Any digital annotations and manipulations made to the document 260 in the work area 270 preferably appear on the document in real time as they are being made by the user, to simulate the process of annotation and manipulation of physical documents. Preferably, the user may hide the tools display 300 or document list 280, if desired.

Each room preferably includes a group display device suitable to display images to all or several persons in a group in each room of the conference. The group display device can include a projector 220 operable to project an image onto a projection surface (not shown) such as a projection screen or wall. The projector 220 is operable to simultaneously project a number of digital content items on to the projection surface, with each document in one of a plurality of predetermined image display locations. Further, all of the projectors 220 in a conference and all of the easels in a conference are preferably synchronized such that they display/project the same images in each room. Preferably, each easel 210 includes a number of image display areas 350, 360, 370, 380, each corresponding to one of the predetermined image display locations of the group display device. To project a document 260 via the projector 220, the user places the document 260 in the work area 270 of the easel 210 as described above, and then selects the desired image display location on the easel 210 by selecting an associated display location selection tab 390 via the pointing device (or via a hand gesture command). Alternatively or additionally, the user may drag the document 260 from the shared digital content item list directly to the desired image display area of the digital easel or an associated display location selection tab 390. Upon selection of the desired image display area on the easel 210, the system preferably automatically displays the content item at the associated image display location of the group display device in all conference rooms in the conference call. Additionally, upon such selection, the content item is preferably simultaneously displayed at the image display area on the easel 210 (also preferably in all conference rooms), for example in a “thumbnail” or reduced-size image.

Each display location selection tab 390 is preferably located immediately adjacent (for example, immediately below) the associated image display area on the easel 210.

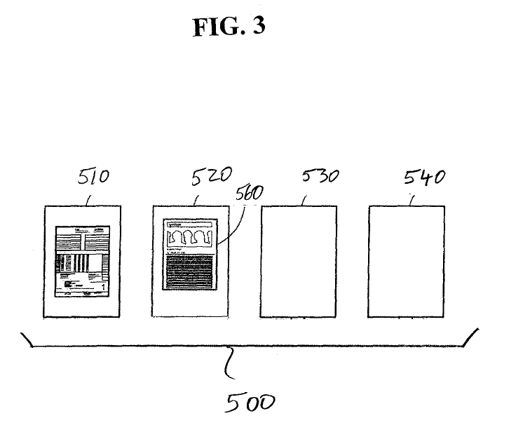

Referring to FIG. 3, as an alternative, the group display device 500 can include a number of electronic display monitors 510, 520, 530, 540, such as large-format, flat-panel LCD or plasma screens, or other suitable monitors, each of which can serve as one or more image display locations and is operable to display one or more content items 560 placed in one or more of the image display areas 350, 360, 370, 380 in the manner described above. Preferably, the system includes one such monitor for each image display area 350, 360, 370, 380 and the monitors are aligned in “portrait” orientation, with the long axes thereof substantially parallel. The monitors can be mounted on a wall or other support and can be closely spaced together or spaced apart as desired. Preferably, each monitor is connected to the local collaboration server 230, which generates a video signal for display on each of the monitors in response to instructions received from the user. Alternatively, one or more other video signal generation devices can be employed to generate the video signals for the monitors. The selection of content items and the display of the content items automatically and simultaneously on the image display areas and locations and in all the rooms in the conference preferably occurs in the manner described above.

Preferably, all of the easels 210 in a conference are instantly synchronized such that operations and images displayed by one easel 210 are replicated on all other easels in a conference. Thus, annotation and manipulation of documents made by a user on an easel 210 in a first room are immediately displayed on all other easels 210 in every other room in the conference. Optionally, users in different rooms in a conference operating on different easels 210 may separately or jointly annotate and manipulate documents and project such documents on the projection surfaces at the same time or sequentially.

To provide interconnectivity and communication, each room in a conference preferably includes a local collaboration server 230 which is connected to the easel 210, the projector 220 and, optionally, other equipment within the room, and to the central server 250 via the network 60. As can be appreciated the interconnections within a conference room may be accomplished via wired or wireless connections or a combination thereof.

Each room in the conference may include a document camera 400 (usually mounted in or on a ceiling of the room) connected to the digital easel 210 in the room, such as via the local collaboration server 230. The document camera 400 is configured to capture an image of a predefined area of a surface 410, for example a horizontal area of an associated conference table 50, or some other surface, to bring a snapshot of a physical document or object into the conference session.

To bring a snapshot of a document into the digital easel 210, the user selects a document camera icon 420 on the display. Upon selection of the document camera icon 420, the digital easel 210 preferably presents a live video preview of the field of view of the document camera 400 in the work area 270 of the display. Selecting the document camera icon 420 again (or selecting another icon) causes the system to capture an image of the then present field of view and the system then adds that image to the shared digital content item list presented in the digital easel. Thus, at this point the captured image becomes like any other digital content item in the system and may be annotated and published to all rooms in the conference in the manner described above.

Digital content items may be introduced into the digital easel 210 and system by inserting a portable storage device, such as USB disk or key into a data port of the digital easel 210, such as a USB port 440 in digital easel 210. Inserting a compatible storage device into the data port 440 will cause a portable storage device icon 430 to appear on the display of the digital easel 210. Selecting the digital storage device icon 430 presents a list of digital content items on the storage device. Digital content items in the list may be dragged and dropped into shared digital content item list 280 or into the work area 270. This copies the selected content item into the shared digital content item list and the shared repository.

Digital content items may be sent from the shared repository to the portable storage device by dragging and dropping from the item from the shared digital content item list to the portable storage device. This will create a new file on the disk and the new file will contain any additional annotations added via the digital easel.

It should be understood, of course, that the specific form of the invention herein illustrated and described is intended to be representative only, as certain changes may be made therein without departing from the clear teachings of the disclosure. Accordingly, reference should be made to the following appended claims in determining the full scope of the invention.

What is claimed is:

1. A system for digital content collaboration and sharing, comprising:
first and second conference rooms, each room having a digital easel, and having a group display device providing a plurality of image display locations;
each digital easel having a touch sensitive display and a pointing device and being operable to receive annotations and manipulations of digital content items via said pointing device;
said group display device being operable to display a plurality of digital content items, with one digital content item in each of one of said plurality of image display locations;
each digital easel having a plurality of predefined image display areas on said display thereof, each image display area being associated with one of said image display locations of said group display device;
each digital easel being operable to access a plurality of digital content items;
each digital easel being operable to receive a selection of a digital content item for any one of said plurality of image display locations from a user via said pointing device; and
upon receipt of a selection of a selected digital content item for a selected image display location from said user, said system automatically displaying said selected digital content item in said associated image display location of said group display device.

2. A system for digital content collaboration and sharing, as in claim 1, wherein:
upon receipt of said selection of said selected digital content item for said selected image display area from said user, said system is operable to automatically display said selected digital content item in said associated image display location of said group display device and simultaneously in said image display area of said digital easel.

3. A system for digital content collaboration and sharing, as in claim 1, wherein:
said group display device comprises a plurality of monitors and means for generating a video signal for each one of said plurality of monitors.

4. A system for digital content collaboration and sharing, as in claim 1, wherein:
said group display device comprises a projection device operable to project a projected image on a projection surface;
said projected image comprising a plurality of digital content items.

5. A system for digital content collaboration and sharing, as in claim 1, wherein:
each digital easel and projection device of said first and second conference rooms are interconnected via a data network; and
said displays of said digital easels and said projection devices are synchronized over said data network.
